(19) United States
(12) Patent Application Publication
(10) Pub. No.: US 2025/0222521 A1
(43) Pub. Date: Jul. 10, 2025

(54) MACHINING APPARATUS

(71) Applicant: Neturen Co., Ltd., Tokyo (JP)

(72) Inventors: Ryosuke Suzuki, Tokyo (JP); Norimasa Sunaga, Tokyo (JP); Daiki Sakamoto, Tokyo (JP)

(21) Appl. No.: 19/093,656

(22) Filed: Mar. 28, 2025

Related U.S. Application Data
(62) Division of application No. 17/954,003, filed on Sep. 27, 2022.

(30) Foreign Application Priority Data
Sep. 30, 2021 (JP) 2021-160754
Sep. 30, 2021 (JP) 2021-160772
Sep. 30, 2021 (JP) 2021-160839

(51) Int. Cl. B23B 7/12; B23B 25/00; H05B 6/10

(52) U.S. Cl. CPC B23B 7/12; B23B 25/00; H05B 6/102

(57) ABSTRACT

A machining apparatus includes: a support mechanism that supports a workpiece; a cutting mechanism that cuts the workpiece that has been supported by the support mechanism; and a heat treatment mechanism that performs heat treatment on the workpiece that has been supported by the support mechanism. The heat treatment mechanism includes a coil that performs induction heating on the workpiece. The coil and the workpiece that has been supported by the support mechanism are movable relative to each other.

### BACKGROUND

### Technical Field

The present disclosure relates to a machining apparatus.

### Related Art

A machining apparatus that is capable of performing laser hardening in addition to cutting treatment is disclosed in JP-A-2005-238253.

### SUMMARY

It is an object of the present disclosure to provide a machining apparatus that is capable of efficiently performing cutting treatment and heat treatment, such as quenching, on a workpiece.

A machining apparatus according to an embodiment of the present disclosure includes: a support mechanism that supports a workpiece; a cutting mechanism that cuts the workpiece that has been supported by the support mechanism; and a heat treatment mechanism that performs heat treatment on the workpiece that has been supported by the support mechanism. The heat treatment mechanism includes a coil that performs induction heating on the workpiece. The workpiece that has been supported by the support mechanism and the coil are movable relative to each other.

According to the embodiment of the present disclosure, the heat treatment mechanism employs induction heating performed by the coil. Induction heating is efficient because heating can be accurately and rapidly performed to a desired temperature. In addition, according to the embodiment of the present disclosure, cutting treatment and heat treatment using induction heating can be continuously performed, and this results in an increase in efficiency. Further, the coil and the workpiece are movable relative to each other, and therefore heat treatment using induction heating can be performed on a desired place of the workpiece. This results in an increase in efficiency.

In addition, it is preferable that the machining apparatus according to the embodiment of the present disclosure further include: a cutting fluid recovery mechanism that recovers cutting fluid that has been supplied to the workpiece in cutting; and a coolant recovery mechanism that recovers coolant that has been supplied to the workpiece in the heat treatment.

By employing such a configuration, the cutting fluid recovery mechanism and the coolant recovery mechanism are included, and this enables reuse of cutting fluid and coolant.

In addition, in the machining apparatus according to the embodiment of the present disclosure, it is preferable that the workpiece have a bar shape, the support mechanism include a first support that supports a first end in an axial direction of the workpiece, and a second support that supports a second end in the axial direction of the workpiece, the coil have an annular shape that surrounds a side face of the workpiece, a steady rest mechanism that suppresses axial deflection of the workpiece in cutting be further included, and the steady rest mechanism be movable to separate the first end from the first support, or separate the second end from the second support, in a state where the workpiece is supported.

By employing such a configuration, the steady rest mechanism is movable to separate the first end of the workpiece from the first support, or separate the second end of the workpiece from the second support. This enables the workpiece to be easily extracted from or inserted into the coil having an annular shape.

In addition, in the machining apparatus according to the embodiment of the present disclosure, it is preferable that the workpiece have a bar shape, the support mechanism include a first support that supports a first end in an axial direction of the workpiece, and a second support that supports a second end in the axial direction of the workpiece, the coil include a curved face that faces a side face of the workpiece, and the coil and the workpiece that has been supported by support mechanism be movable relative to each other to arbitrarily adjust a distance between the curved face and the workpiece.

By employing such a configuration, the coil including the curved face, as described above, and the workpiece supported by the support mechanism are movable relative to each other to arbitrarily adjust a distance between the curved face and the workpiece. This enables the coil to be easily disposed in an arbitrary place of the workpiece on which induction heating is to be performed, in comparison with a coil having an annular shape.

A machining apparatus according to an embodiment of the present disclosure includes: a support mechanism that supports a workpiece; a cutting mechanism that cuts the workpiece that has been supported by the support mechanism; a heat treatment mechanism including a coil that moves relative to the workpiece that has been supported by the support mechanism, and performs induction heating on the workpiece; and a steady rest mechanism that suppresses axial deflection in the induction heating of the workpiece that has been supported by the support mechanism.

According to the embodiment of the present disclosure, the heat treatment mechanism employs induction heating performed by the coil. Induction heating is efficient because heating can be accurately and rapidly performed to a desired temperature. In addition, the workpiece supported by the support mechanism and the coil move relative to each other, and therefore the heat treatment mechanism according to the embodiment of the present disclosure can perform heat treatment using induction heating on a desired place of the workpiece. This results in a further increase in efficiency. Moreover, according to the embodiment of the present disclosure, the steady rest mechanism suppresses axial deflection in induction heating of the workpiece supported by the support mechanism. Therefore, the heat treatment mechanism can perform heat treatment with high quality.

It is preferable that the steady rest mechanism be movable relative to the workpiece that has been supported by the support mechanism, and the steady rest mechanism move relative to the workpiece between a contact position and a non-contact position. In the contact position, the steady rest mechanism comes into contact with the workpiece. In the non-contact position, a space is formed between the steady rest mechanism and the workpiece in such a way that the heat treatment mechanism that moves relative to the workpiece can pass through the space.

By employing such a configuration, the steady rest mechanism is moved relative to the workpiece between the contact position and the non-contact position, as needed, and therefore induction heating can be continuously performed on the workpiece in a state where the steady rest mechanism does not hinder a movement of the coil relative to the workpiece. This results in an increase in efficiency. In addition, continuous induction heating causes a temperature of the workpiece to be easily uniformized, and this enables heat treatment to be performed with high quality.

It is preferable that the cutting mechanism be movable relative to the workpiece that has been supported by the support mechanism, and the cutting mechanism move relative to the workpiece between the contact position and the non-contact position. In the contact position, the cutting mechanism comes into contact with the workpiece. In the non-contact position, a space is formed between the cutting mechanism and the workpiece in such a way that the heat treatment mechanism that moves relative to the workpiece can pass through the space.

By employing such a configuration, the cutting mechanism in addition to the steady rest mechanism is moved relative to the workpiece between the contact position and the non-contact position, and therefore the cutting mechanism does not hinder a movement of the coil relative to the workpiece either. Thus, treatment smoothly proceeds between cutting treatment and heat treatment, and this results in a further increase in efficiency.

In a case where cutting treatment and heat treatment are simultaneously performed, a movement of the coil relative to the workpiece is not hindered by the cutting mechanism either, and induction heating can be continuously performed on the workpiece. This results in a yet further increase in efficiency. Moreover, this continuous induction heating causes a temperature of the workpiece to be easily uniformized, and this enables heat treatment to be performed with high quality.

It is preferable that the workpiece have a bar shape, and the coil have an annular shape that can surround the workpiece.

By employing such a configuration, the coil has an annular shape that can surround the workpiece, and therefore induction heating on a side face of the workpiece is easily uniformized in a circumferential direction. This enables heat treatment to be performed with higher quality.

The workpiece may have a bar shape, and the coil may include a curved face that can face the side face of the workpiece.

By employing such a configuration, the coil includes the curved face that can face the side face of the workpiece having a bar shape. Therefore, the coil is relatively easily brought closer to the workpiece to a position that causes induction heating to be performed on the workpiece supported by the support mechanism (specifically, in comparison with a coil having an annular shape), and this results in an increase in efficiency.

A machining apparatus according to an embodiment of the present disclosure includes: a table that enables a workpiece to rotate; a workpiece supporter that is disposed on the table, and supports the workpiece; a cutting mechanism that cuts the workpiece that has been supported by the workpiece supporter; and a heat treatment mechanism that performs heat treatment on the workpiece that has been supported by the workpiece supporter. The heat treatment mechanism includes a coil that performs induction heating on the workpiece, and the coil and the workpiece that has been supported by the workpiece supporter are movable relative to each other.

According to the embodiment of the present disclosure, the heat treatment mechanism employs induction heating performed by the coil. Induction heating is efficient because heating can be accurately and rapidly performed to a desired temperature. In addition, according to the embodiment of the present disclosure, cutting treatment and heat treatment using induction heating can be continuously performed, and this results in an increase in efficiency. Further, the coil and the workpiece are movable relative to each other, and therefore heat treatment using induction heating can be performed on a desired place of the workpiece. This results in a further increase in efficiency.

In addition, the machining apparatus according to the embodiment of the present disclosure further includes a machining chamber that houses the cutting mechanism, the heat treatment mechanism, and the table. A plurality of tables, a plurality of workpiece supporters, a plurality of palettes, and a palette changer are included. The plurality of workpiece supporters is respectively disposed on the plurality of tables, and each supports the workpiece. The plurality of tables is respectively placed on the plurality of palettes. The palette changer exchanges the plurality of palettes between an inside and an outside of the machining chamber.

By employing such a configuration, a palette changer, as described above, is included, and this enables workpieces before and after treatment to be exchanged between an inside and an outside of the machining chamber.

In addition, the machining apparatus according to the embodiment of the present disclosure further includes a coolant recovery mechanism that recovers coolant that has been supplied to the workpiece in heat treatment.

By employing such a configuration, the coolant recovery mechanism is included, and this enables reuse of coolant.

As described above, according to an embodiment of the present disclosure, a machining apparatus that is capable of efficiently performing cutting treatment and heat treatment, such as quenching, on a workpiece is provided.

### BRIEF DESCRIPTION OF DRAWINGS

FIG. 1 is a schematic diagram of a machining apparatus according to an embodiment, and illustrates a state where a workpiece is in contact with a cutting mechanism and a steady rest device;

FIG. 2 illustrates a state where the cutting mechanism and the steady rest device have been separated from the workpiece in FIG. 1;

FIGS. 3A to 3C are conceptual diagrams illustrating a shape of a shaft that is an example of a workpiece to be machined by the machining apparatus of FIG. 1, FIG. 3A is a side view, and FIGS. 3B and 3C are perspective views;

FIG. 4 is a schematic diagram illustrating a variation of a coolant recovering mechanism;

FIG. 5 is a schematic diagram illustrating a variation of a coil in a heat treatment mechanism;

FIG. 6 is a schematic diagram illustrating an example of a movement of the coil;

FIG. 7 is a schematic diagram of a machining apparatus in a first aspect of a third embodiment;

FIG. 8 is a schematic diagram of a machining apparatus in a second aspect of the third embodiment;

FIG. 9 is a schematic diagram illustrating a variation of a table (a workpiece supporter); and

FIG. 10 is a schematic diagram illustrating a variation of a coil in a heat treatment mechanism.

### DETAILED DESCRIPTION

The inventors have made the following consideration, and have created the present disclosure.

First, induction heating is efficient because a workpiece can be accurately and rapidly heated to a desired temperature. In view of this, the inventors have conceived of employing induction heating instead of laser hardening disclosed in JP-A-2005-238253. However, it is requested that heat treatment mechanisms that are different in a heating system have respective peculiar specifications. For example, in induction heating, disposition of a coil relative to a workpiece is important. Therefore, it is requested that a machining apparatus have an increased efficiency while such a request is satisfied.

### First Embodiment

A machining apparatus according to an embodiment of the present disclosure is described below with reference to the drawings.

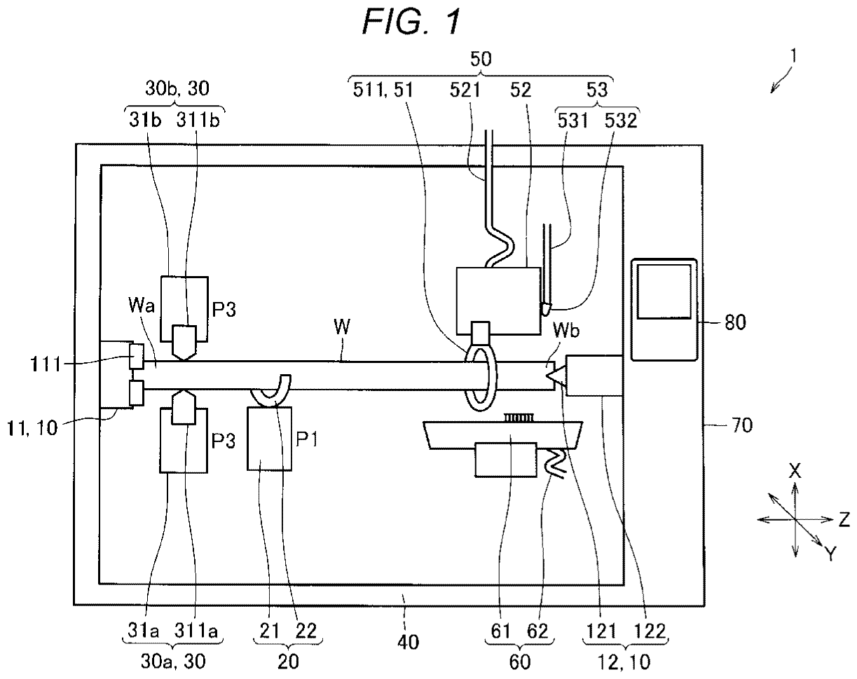

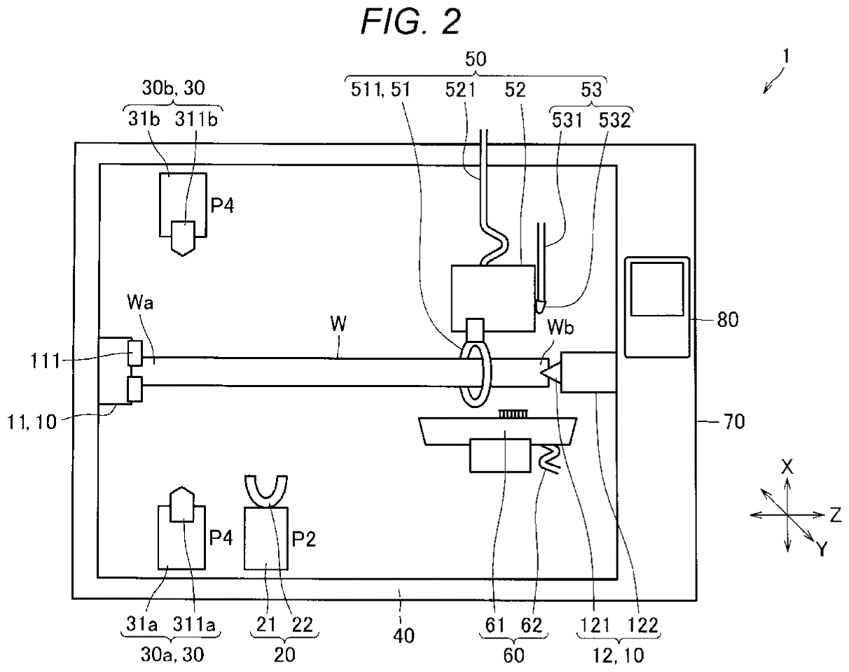

FIGS. 1 and 2 are schematic diagrams of a machining apparatus according to an embodiment of the present disclosure. As illustrated in FIGS. 1 and 2, a machining apparatus 1 according to the present embodiment includes a support mechanism 10 that supports a workpiece W having a bar shape, a steady rest mechanism 20 that suppresses axial deflection of the workpiece W in cutting, a cutting mechanism 30 that cuts the workpiece W supported by the support mechanism 10, a cutting fluid recovery mechanism 40 that recovers cutting fluid that has been supplied to the workpiece W in cutting, a heat treatment mechanism 50 that performs heat treatment on the workpiece W supported by the support mechanism 10, and a coolant recovery mechanism 60 that recovers coolant that has been supplied to the workpiece W in heat treatment. The machining apparatus 1 also includes a controller 80 that controls an operation of each of the mechanisms. Note that the machining apparatus 1 may include a machining chamber 70 that houses each of the mechanisms.

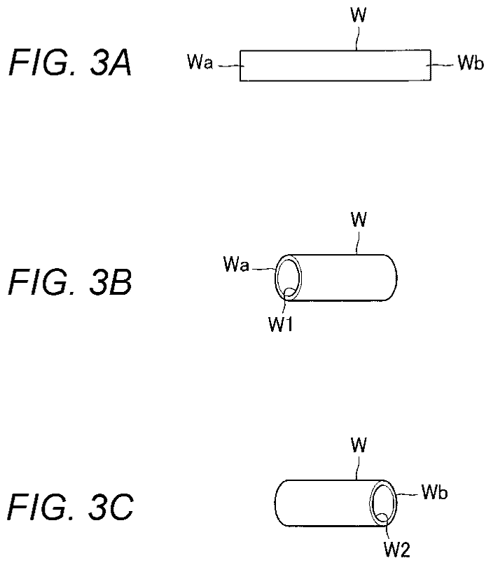

FIGS. 3A to 3C are conceptual diagrams illustrating an example of a workpiece to be machined by the machining apparatus 1. FIG. 3A is a side view, and FIGS. 3B and 3C are perspective views. As illustrated in FIGS. 3A to 3C, the workpiece W according to the present embodiment is a shaft that is hollow and has a cylindrical shape. The workpiece W includes a first end Wa, a second end Wb that is located on an opposite side of the first end Wa in an axial direction of the workpiece W, an opening W1 that is located in the first end Wa, and an opening W2 that is located in the second end Wb. In addition, the workpiece W has been made of steel containing carbon. An example of such a workpiece W is a hollow rack bar that is used in a steering device of an automobile or the like. The rack bar includes not-illustrated teeth that mesh with teeth of a pinion gear. Note that the workpiece W may be solid. In addition, in the present embodiment, the workpiece W that is a shaft is described as an example. However, a shape or a purpose of the workpiece W is not particularly limited.

The machining apparatus 1 according to the present embodiment is a composite apparatus that supports the workpiece W in such a way that an axis of the workpiece W is disposed along a horizontal direction, and can perform both cutting treatment and heat treatment on the workpiece W, as illustrated in FIGS. 1 and 2.

Note that hereinafter, an axial direction of the workpiece W in a supported state is referred to as a Z-direction, and a direction that is orthogonal to the Z-direction in the horizontal direction is referred to as a Y-direction. In addition, a direction that is orthogonal to the Z-direction and the Y-direction in a vertical direction is referred to as an X-direction.

The support mechanism 10 according to the present embodiment includes a first support 11 that supports the first end Wa of the workpiece W, and a second support 12 that supports the second end Wb of the workpiece W, as illustrated in FIGS. 1 and 2. The first support 11 and the second support 12 are disposed to face each other in the Z-direction.

The first support 11 includes a plurality of claws 111 that grasps a side face of the workpiece W. Each of the plurality of claws 111 is disposed at equal intervals on a concentric circle. In addition, each of the plurality of claws 111 can advance or retreat relative to the side face of the workpiece W. Further, the first support 11 is rotatable to rotate the workpiece W in the supported state around the axis. As such a first support 11, for example, an independent chuck, a hydraulic power chuck, or a collet chuck can be employed.

The second support 12 includes a rotation center 121 that presses a distal end against an end face of the workpiece W by bringing the distal end into contact with the end face of the workpiece W, and a tailstock 122 that causes the rotation center 121 to advance or retreat relative to the end face of the workpiece W. The rotation center 121 and the tailstock 122 are disposed on an identical axis line. The rotation center 121 includes a tapered face that is tapered toward the distal end. The rotation center 121 advances into the second end Wb of the workpiece W to cause the tapered face to abut onto an inner peripheral edge of the opening W2 in the workpiece W, and supports the workpiece W. Note that in the case of a solid workpiece W, the second end Wb of the workpiece W includes a not-illustrated center hole into which the distal end of the rotation center 121 can be inserted, and the second support 12 causes the distal end of the rotation center 121 to abut onto an inner peripheral edge of the center hole, and supports the workpiece W. In addition, the workpiece W supported by the rotation center 121 can advance or retreat in the Z-direction by using the tailstock 122. Further, the second support 12 is rotatable to rotate the workpiece W in the supported state around the axis.

Accordingly, the workpiece W is rotatable around the axis in a state where the workpiece W is supported by the first support 11 and the second support 12.

The first support 11 and the second support 12 have been formed by using, for example, a material having predetermined hardness.

The steady rest mechanism 20 according to the present embodiment receives the side face of the workpiece W from below to suppress axial deflection of the workpiece W in cutting and in heat treatment. More specifically, in a case where the machining apparatus 1 performs cutting treatment or heat treatment while rotating the workpiece W around the axis, the steady rest mechanism 20 suppresses axial deflection of the workpiece W that rotates around the axis.

The steady rest mechanism 20 includes a body 21 serving as a foundation, and a clamp 22 that extends upward from an upper end of the body 21.

In the present embodiment, the steady rest mechanism 20 moves relative to the workpiece W supported by the support mechanism 10. Note that the workpiece W may move relative to the steady rest mechanism 20. As illustrated in FIGS. 1 and 2, the steady rest mechanism 20 moves between a contact position P1 (the position of FIG. 1) and a non-contact position P2 (the position of FIG. 2). In the contact position P1, the body 21 is in contact with the workpiece W supported by the support mechanism 10. In the non-contact position P2, a space (a clearance) is disposed between the steady rest mechanism 20 and the workpiece W in such a way that at least a coil 51 of the heat treatment mechanism 50 that moves relative to the workpiece W (preferably, the heat treatment mechanism 50 and the coolant recovery mechanism 60 (described later) that moves to follow the heat treatment mechanism 50) can pass.

By doing this, the machining apparatus 1 moves the steady rest mechanism 20 relative to the workpiece W between the contact position P1 and the non-contact position P2, as needed, and can continuously perform induction heating on the workpiece W in a state where the steady rest mechanism 20 does not hinder a movement of the coil 51 relative to the workpiece W. This results in an increase in efficiency. In addition, the steady rest mechanism 20 does not hinder a movement of the coil 51, and therefore control can be performed to obtain a uniform speed or the like of a movement of the coil 51 relative to the workpiece. Accordingly, the machining apparatus 1 easily uniformizes induction heating performed by the heat treatment mechanism 50, and therefore heat treatment can be performed with high quality.

Stated another way, the body 21 is movable in the Z-direction. Specifically, the steady rest mechanism 20 includes a driver (not illustrated) that drives a movement in the Z-direction of the body 21, and a first guide (not illustrated), such as a rail, that guides a movement in the Z-direction of the body 21, and this enables the body 21 to move in the Z-direction.

A movement in the Z-direction of the body 21 enables the steady rest mechanism 20 to be disposed in a preferable position to suppress axial deflection of the workpiece W. This avoids hindrance of a movement in the Z-direction of another mechanism (specifically, the heat treatment mechanism 50 or the coolant recovery mechanism 60 that is described later) due to the steady rest mechanism 20.

The clamp 22 has a function of a grasping portion that grasps a lower face and the side face of the workpiece W and avoids falling of the workpiece W.

In addition, the clamp 22 can advance or retreat relative to the workpiece W supported by the support mechanism 10. Specifically, the clamp 22 can advance or retreat (move) between the contact position P1 and the non-contact position P2 (below the workpiece W). In the contact position P1, the clamp 22 can be in contact with the workpiece W supported by the support mechanism 10. In the non-contact position P2, a space is disposed between the clamp 22 and the workpiece W in a supported state, and the coil 51 described later (more specifically, the coil 51 in a state where the workpiece W is disposed in the coil 51) can pass in the Z-direction. For example, the clamp 22 may be connected to a cylinder that causes advance or retreat (a movement) between the contact position P1 and the non-contact position P2. This avoids hindrance of a movement in the Z-direction of the coil 51 (more specifically, the coil 51 in a state where the workpiece W is disposed in the coil 51) due to the clamp 22.

In addition, the clamp 22 can move the grasped workpiece W from a support position of the support mechanism 10 to an arbitrary position. Specifically, the clamp 22 can move the workpiece W between a support position and a non-support position. In the support position, the support mechanism 10 supports the workpiece W. In the non-support position, a clearance is disposed between the first end Wa of the workpiece W released from the support mechanism 10 and the first support 11 or between the second end Wb and the second support 12.

In addition, the clearance has a size that enables the workpiece W to be extracted from or inserted into the coil 51 having an annular shape in the first end Wa or the second end Wb of the workpiece W. The steady rest mechanism 20 includes the clamp 22, as described above, and therefore the machining apparatus 1 can efficiently perform a task of extracting or inserting the coil 51 having an annular shape.

The cutting mechanism 30 according to the present embodiment includes a first cutting mechanism 30a that is disposed below the support mechanism 10, and a second cutting mechanism 30b that is disposed above the support mechanism 10. The first cutting mechanism 30a includes a cutter holder 31a that supports a cutting tool 311a that cuts the workpiece W. Similarly, the second cutting mechanism 30b includes a cutter holder 31b that supports a cutting tool 311b that cuts the workpiece W. The cutter holder 31a or 31b includes a cutting fluid supplier (not illustrated) that supplies cutting fluid to the workpiece W, and a cutting fluid tank (not illustrated) that stores cutting fluid.

In the present embodiment, the cutting mechanism 30 moves relative to the workpiece W supported by the support mechanism 10. As illustrated in FIGS. 1 and 2, the cutting mechanism 30 moves between a contact position P3 (the position of FIG. 1) and a non-contact position P4 (the position of FIG. 2). In the contact position P3, the cutter holder 31 brings the cutting tool 311 into contact with the workpiece W supported by the support mechanism 10. In the non-contact position P4, a space (a clearance) is disposed between the workpiece W and the cutting mechanism 30 in such a way that at least the coil 51 of the heat treatment mechanism 50 that moves relative to the workpiece W (preferably, the heat treatment mechanism 50 and the coolant recovery mechanism 60 (described later) that moves to follow the heat treatment mechanism 50) can pass.

Accordingly, the machining apparatus 1 moves the cutting mechanism 30 in addition to the steady rest mechanism 20 relative to the workpiece W between the contact position P3 and the non-contact position P4, and therefore the cutting mechanism 30 does not hinder a movement of the coil 51 relative to the workpiece W either. Thus, treatment smoothly proceeds between cutting treatment performed by the cutting mechanism 30 and heat treatment performed by the heat treatment mechanism 50, and this results in an increase in efficiency. In addition, the cutting mechanism 30 does not hinder a movement, and therefore control can be performed to obtain a uniform speed or the like of a movement of the coil 51 relative to the workpiece W. Accordingly, the machining apparatus 1 easily uniformizes induction heating performed by the heat treatment mechanism 50, and this enables heat treatment to be performed with higher quality.

The cutter holder 31a is movable in the X-direction and the Z-direction. Specifically, the first cutting mechanism 30a includes a driver (not illustrated) that drives a movement in the X-direction and the Z-direction of the cutter holder 31a, and a second guide (not illustrated), such as a rail, that guides a movement in the X-direction and the Z-direction of the cutter holder 31a, and this enables the cutter holder 31a to move in the X-direction and the Z-direction. Similarly, the second cutting mechanism 30b includes a driver (not illustrated) that drives a movement in the X-direction and the Z-direction of the cutter holder 31b, and a third guide (not illustrated) that guides a movement in the X-direction and the Z-direction of the cutter holder 31b, and this enables the cutter holder 31b to move in the X-direction and the Z-direction.

Note that the cutter holder 31a that is disposed below the workpiece W may be guided by the first guide of the steady rest mechanism 20 instead of the second guide. Stated another way, the cutter holder 31a and the steady rest mechanism 20 may share a single guide.

The cutting tool 311a or 311b also moves in the Z-direction according to a movement in the Z-direction of the cutter holder 31a or 31b, and therefore cutting treatment can be performed on the workpiece W in a predetermined position in the Z-direction.

The cutter holder 31a or 31b can rotate the cutting tool 311a or 311b around an axis of the cutting tool 311a or 311b (with the X-direction as an axis). In addition, the cutter holder 31a or 31b may rotationally move the cutting tool 311a or 311b in such a way that the cutting tool 311a or 311b enters into a first state where the rotation axis of the cutting tool 311a or 311b is located along one direction, or a second state where the rotation axis is inclined in an arbitrary direction relative to the first state. As the cutting tool 311a or 311b, for example, a milling cutter and an end mill can be used in a case where the cutting tool 311a or 311b is rotated. In a case where the cutting tool 311a or 311b is not rotated, for example, a throw-away tip of cemented carbide can be used.

The cutting fluid supplier moves together with the cutting tool 311a or 311b according to a movement of the cutter holder 31a or 31b such that cutting fluid can be supplied to a cut face of the workpiece W.

The cutting fluid recovery mechanism 40 according to the present embodiment is a circulation type mechanism that performs filtration treatment on cutting fluid supplied to the workpiece W, and supplies the cutting fluid supplier with cutting fluid from which a chip has been removed. Specifically, the cutting fluid recovery mechanism 40 includes a receiver (not illustrated) that has been embedded into, for example, a bottom of the machining chamber 70, and receives cutting fluid including a chip, a leader (not illustrated) that leads cutting fluid to the receiver, a filter (not illustrated) that is located to cross a flow direction of the cutting fluid, and separates the chip from the cutting fluid, and a pump (not illustrated) that supplied the cutting fluid supplier with the cutting fluid that has passed through the filter. The leader may be an inclined plane that is inclined downward toward the receiver, or an inclined groove that is inclined downward toward the receiver. The filter may be located in the middle of the leader, or may be located between the leader and the receiver. In addition, the receiver may have a tubular shape, and the filter may be located to cross the flow direction of the cutting fluid in the receiver.

Note that in a case where the machining chamber 70 is not included, the cutting fluid recovery mechanism 40 is disposed on a lower side in the X-direction of the cutting mechanism 30.

The heat treatment mechanism 50 according to the present embodiment performs quenching for hardening a surface of the workpiece W. The heat treatment mechanism 50 is disposed above the support mechanism 10.

The heat treatment mechanism 50 includes the coil 51 that performs induction heating on the workpiece W, a high-frequency power supply 52 that adjusts a frequency of a voltage to be applied to the coil 51, a coolant supplier 53 that supplies the workpiece W with coolant, and a coolant tank (not illustrated) that stores coolant. In the present embodiment, the coil 51 and the coolant supplier 53 are mounted on the high-frequency power supply 52. In addition, the high-frequency power supply 52 is movable relative to the workpiece W. Accordingly, the coil 51 and the coolant supplier 53 are movable relative to the workpiece W according to a movement of the high-frequency power supply 52 relative to the workpiece W.

The coil 51 performs induction heating on the workpiece W in such a way that a temperature on a surface of the workpiece W becomes 100° C. to 1200° C.

The coil 51 includes an annular portion 511 that can surround the side face of the workpiece W. The annular portion 511 has been formed by using a copper tube that spirally runs along a circle having a predetermined diameter. In other words, the coil 51 includes an annular turn coil having a predetermined diameter. Accordingly, the machining apparatus 1 can uniformize induction heating performed on the workpiece W by the coil 51 in a circumferential direction of the side face of the workpiece W. Therefore, heat treatment can be performed with higher quality.

In addition, an inner diameter of the annular portion 511 is larger than a diameter of the second support 12. When the coil 51 has been moved in the Z-direction, the annular portion 511 can surround a side face of the second support 12.

The coil 51 is movable in the Z-direction in a state where the workpiece Wis disposed inside the coil 51. Stated another way, the workpiece W supported by the support mechanism 10 and the coil 51 are movable relative to each other. In addition, when the workpiece W moves between the support position and the non-support position by using the clamp 22 of the steady rest mechanism 20, the coil 51 is movable according to a movement of the clamp 22 in a state where the workpiece W is disposed inside the coil 51. In other words, the high-frequency power supply 52 is movable according to a movement of the clamp 22.

In the present embodiment, the coil 51 is mounted on the high-frequency power supply 52, as described above. In addition, the coil 51 and the high-frequency power supply 52 are connected to each other by a coil lead (not illustrated). The high-frequency power supply 52 is, for example, a matching transformer or a current transformer.

In addition, the coil 51 and the coil lead may be covered with a cover member (not illustrated) that is used to avoid a short circuit due to a chip.

However, less power is lost in a case where the coil 51 and the high-frequency power supply 52 are connected by a short coil lead. Therefore, it is preferable that the coil 51 be mounted on the high-frequency power supply 52. In addition, in order to avoid attachment of a chip or cutting fluid to the coil 51 in cutting treatment, it is preferable that the coil 51 be mounted on the high-frequency power supply 52.

Further, in the coil 51, a frequency of a voltage to be applied to the workpiece W ranges, for example, from 0.3 kHz to 400 kHz. This enables high-frequency induction heating to be generated in the workpiece W. The frequency can be set according to a model or specifications of the high-frequency power supply.

The high-frequency power supply 52 includes a cold-water cable 521 that is used to supply cold water to be internally circulated.

The high-frequency power supply 52 is movable in the X-direction and the Z-direction. Specifically, the heat treatment mechanism 50 includes a driver (not illustrated) that drives a movement in the X-direction and the Z-direction of the high-frequency power supply 52, and a fourth guide (not illustrated), such as a rail, that guides a movement in the X-direction and the Z-direction of the high-frequency power supply 52, and this enables the high-frequency power supply 52 to move in the X-direction and the Z-direction. In addition, the fourth guide extends to be able to guide the heat treatment mechanism 50 to a position where the heat treatment mechanism 50 does not overlap the workpiece W, when viewed from one side of the Z-direction.

Note that the high-frequency power supply 52 that is disposed above the workpiece W may be guided by the third guide of the second cutting mechanism 30b instead of the fourth guide. Stated another way, the heat treatment mechanism 50 and the second cutting mechanism 30b may share a single guide.

The coil 51 and the coolant supplier 53 also move in the Z-direction according to a movement in the Z-direction of the high-frequency power supply 52, and this enables heat treatment to be performed in a predetermined position in a longitudinal direction of the workpiece W. In addition, the coil 51 and the coolant supplier 53 also move in the X-direction according to a movement in the X-direction of the high-frequency power supply 52, and this enables the heat treatment mechanism 50 to retreat to a further upper side of the workpiece W, when viewed from one side of the Z-direction. This avoids hindrance of a movement in the Z-direction of the second cutting mechanism 30b due to the heat treatment mechanism 50.

The coolant supplier 53 can supply the workpiece W with coolant within 3.0 seconds after induction heating of the workpiece W. The coolant supplier 53 includes a nozzle 531 that injects coolant to the workpiece W, and a branch pipe 532 that has a long shape, and has been branched from the nozzle 531.

The nozzle 531 injects coolant to a predetermined place of the workpiece W. For example, the nozzle 531 may be able to inject coolant in a direction that is inclined by a predetermined angle relative to the X-direction, by inclining the nozzle 531. A terminal end (an end on an opposite side of a connection end of the nozzle 531) of the branch pipe 532 is connected to the coolant tank with a pump interposed therebetween.

While operation is not performed, the heat treatment mechanism 50 according to the present embodiment is stored in an isolation chamber (not illustrated) in the machining chamber 70. Specifically, while the heat treatment mechanism 50 does not operate and cutting treatment is performed on the workpiece W, the heat treatment mechanism 50 is stored in the isolation chamber in order to avoid attachment of cutting fluid or a chip. Note that the heat treatment mechanism 50 may be protected by an isolation wall that avoids attachment of cutting fluid or a chip.

The coolant recovery mechanism 60 according to the present embodiment is disposed below the support mechanism 10. The coolant recovery mechanism 60 includes a receiver 61 that receives coolant that has been supplied to the workpiece W, and a recovery pipe 62 that recovers coolant of the receiver 61.

The receiver 61 is disposed below the workpiece W supported by the support mechanism 10. The receiver 61 includes a container that is open on an upper side.

The receiver 61 is movable in the X-direction and the Z-direction. Specifically, the coolant recovery mechanism 60 includes a driver (not illustrated) that drives a movement in the X-direction and the Z-direction of the receiver 61, and a fifth guide (not illustrated), such as a rail, that guides a movement in the X-direction and the Z-direction of the receiver 61, and this enables the receiver 61 to move in the X-direction and the Z-direction.

Note that the receiver 61 may be guided by the first guide of the steady rest mechanism 20 or the second guide of the first cutting mechanism 30a instead of the fifth guide. Stated another way, the receiver 61, the steady rest mechanism 20, and the first cutting mechanism 30a may share a single guide.

A movement in the Z-direction of the receiver 61 enables alignment of the coolant recovery mechanism 60 in the longitudinal direction of the workpiece W.

In addition, the receiver 61 is movable along the Z-direction according to a movement of the nozzle 531 (the high-frequency power supply 52). In other words, the receiver 61 is movable in parallel with the nozzle 531 in the Z-direction.

The recovery pipe 62 performs suction to recover coolant. The recovery pipe 62 is connected to the coolant tank. This enables circulation use of coolant.

Here, it can be requested that the heat treatment mechanism 50 that employs induction heating change composition of coolant according to a type of the workpiece W. Examples of coolant include a polymer, water, and a mixture of the polymer and water. It is preferable that coolant including the polymer be recovered from a viewpoint of reuse or in an environmental aspect. In contrast, the coolant recovery mechanism 60 according to the present embodiment suppresses mixture of cutting fluid in coolant, and therefore coolant is easily reused. In addition, an environment aspect can be considered.

The controller 80 according to the present embodiment controls an amount of movement of each of the mechanisms described above, the speed of rotation of the support mechanism 10 or the cutting tool 311, a supply timing or a supply amount of cutting fluid or coolant, and the like.

Next, an operation of the machining apparatus 1 according to the present embodiment is described by using, as an example, a case where heat treatment is performed after cutting treatment has been performed on the workpiece W. Note that the machining apparatus 1 may perform cutting treatment after heat treatment has been performed on the workpiece W. In addition, the machining apparatus 1 may simultaneously perform cutting treatment and heat treatment. Further, the numbers of times of cutting treatment and heat treatment can be appropriately changed or set.

### (Preparation Stage)

First, the machining apparatus 1 supports the workpiece W by using the support mechanism 10. At this time, the clamp 22 of the steady rest mechanism 20 may also support the workpiece W.

Next, centering is performed on the workpiece W in a rotated state around an axis, by using the first support 11 and the second support 12.

Next, in a case where the clamp 22 of the steady rest mechanism 20 does not support the workpiece W, the clamp 22 of the steady rest mechanism 20 is advanced to the workpiece W in such a way that the side face of the workpiece W is received, and the clamp 22 supports the workpiece W.

### (Cutting Treatment Stage)

The machining apparatus 1 moves the cutter holder 31a or 31b to a predetermined position in the axial direction of the workpiece W. At this time, the workpiece W may be rotated around the axis, as needed. Next, the cutting tool 311 is advanced to come into contact with the workpiece W, and the cutting fluid supplier supplies cutting fluid to the workpiece W. Therefore, cutting treatment is performed on the workpiece W. At this time, the cutting tool 311a or 311b may be rotated around the axis, as needed. In addition, cutting fluid is circulated between the cutting fluid recovery mechanism 40 and the cutting fluid supplier.

### (Stage of Transition to Heat Treatment)

After cutting treatment, the second support 12 is caused to retreat, and the second end Wb of the workpiece W is released. Next, the tailstock 122 is moved in the Z-direction to release the workpiece W, and therefore a clearance through which the coil 51 can pass is formed between the second end Wb of the workpiece W and the second support 12. Then, the coil 51 is moved in such a way that the coil 51 is led to the clearance, and the workpiece W is disposed inside the coil 51. After a movement of the coil 51, the workpiece W is supported by the second support 12. In addition, the cutting mechanism 30 is caused to retreat to a position where a movement of the heat treatment mechanism 50 and the coolant recovery mechanism 60 is not hindered.

### (Heat Treatment Stage)

The machining apparatus 1 moves the coil 51 and the nozzle 531 to a predetermined position of the workpiece W, and coolant is supplied to the workpiece W by using the nozzle 531 within a predetermined time period (for example, within 3.0 seconds) after the coil 51 has performed induction heating on the workpiece W. At this time, the workpiece W may be rotated around the axis, as needed. By doing this, a surface of the workpiece W is hardened. In supplying coolant to the workpiece W, the nozzle 531 and the coolant recovery mechanism 60 are moved in parallel in the Z-direction, and the receiver 61 receives coolant that has been supplied to the workpiece W. In addition, coolant is circulated between the coolant recovery mechanism 60 and the coolant supplier 53. Note that in heat treatment, the workpiece W may be rotated around the axis, or may not be rotated.

As described above, an embodiment has been described as an example, but a machining apparatus according to the present disclosure is not limited to a configuration of the embodiment described above. In addition, the machining apparatus according to the present disclosure is not limited to the effects described above. Various changes can be made to the machining apparatus according to the present disclosure without departing from the gist of the present disclosure.

In addition, in the embodiment described above, an aspect in which the second support 12 includes the rotation center 121 and the tailstock 122 has been described. However, this is not restrictive, and the second support 12 may include a plurality of claws similarly to the first support 11.

In addition, in the embodiment described above, the heat treatment mechanism 50 has performed quenching as heat treatment. However, this is not restrictive, and the heat treatment mechanism may perform normalizing, high-frequency tempering, high-frequency heating, high-frequency annealing, or the like.

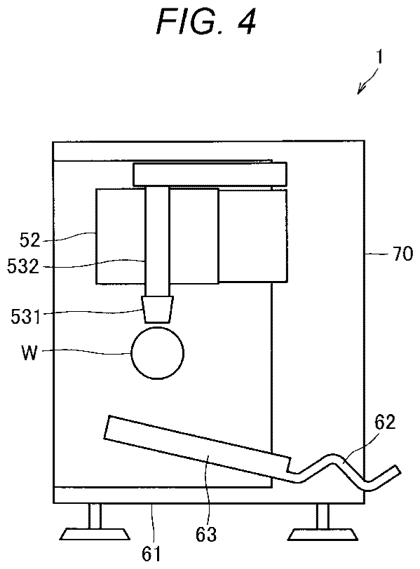

Further, the coolant recovery mechanism may have the aspect illustrated in FIG. 4. Stated another way, the coolant recovery mechanism 60 of FIG. 4 includes a receiver 61 that is disposed in a bottom of the machining chamber 70, and is open on an upper side, a recovery pipe 62 that recovers coolant in the receiver 61, and a leader 63 that is located above the receiver 61, is connected to the recovery pipe 62, and leads coolant in the receiver 61 to the recovery pipe 62. In the aspect of FIG. 4, the leader 63 includes a lower end that is connected to the recovery pipe 62, and an upper end that is disposed below the workpiece W, and is inclined from the upper end to the lower end. Due to such inclination, in the leader 63, coolant is led from the upper end to the lower end.

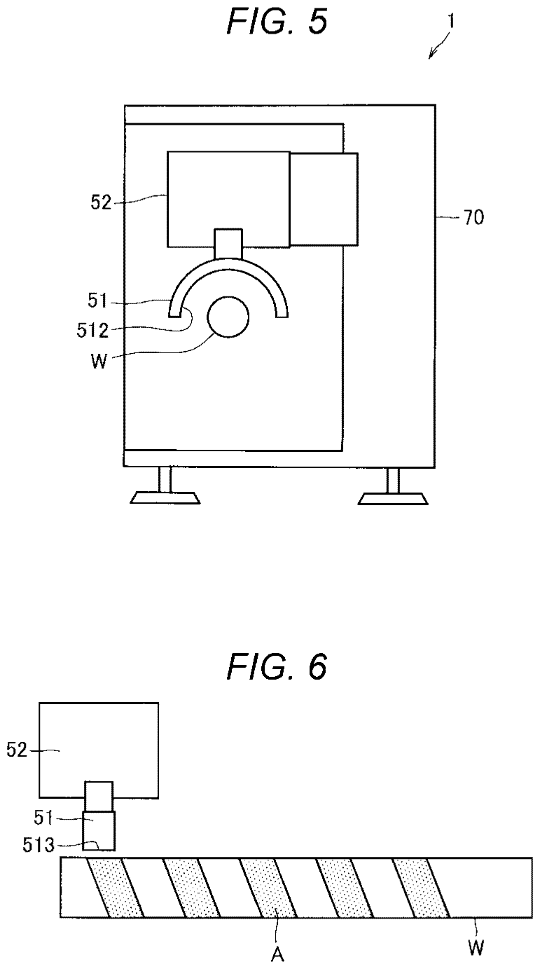

In addition, the coil 51 may have the aspect illustrated in FIG. 5. Stated another way, the coil 51 of FIG. 5 includes a curved face 512 that can face the side face of the workpiece W. In other words, the coil 51 includes a saddle-shaped coil.

In addition, the coil 51 is movable around the workpiece W to arbitrarily adjust a distance between the curved face 512 and the workpiece W.

Accordingly, the coil 51 is easily brought close to the workpiece W to a position where induction heating is generated in the workpiece W supported by the support mechanism 10, in comparison with a coil having an annular coil. This results in an increase in efficiency.

In the case of the coil 51 including the curved face 512, it is preferable that the workpiece W supported by the support mechanism 10 be rotatable to rotate around the axis. The workpiece W is rotatable around the axis, and therefore even the coil 51 having a curved shape can uniformize induction heating in the circumferential direction of the side face of the workpiece W.

In addition, the coil 51 of FIG. 5 may be movable around the workpiece W to arbitrarily adjust a distance between the curved face 512 and the workpiece W. For example, when viewed from one side of the Z-direction, as illustrated in FIG. 5, the curved face 512 has an arc shape. In addition, the coil 51 may be movable to at least a position where a center of an arc in the curved face 512 overlaps a center of the workpiece W, when the coil 51 has moved closer to the workpiece W from above.

A coil may have the aspect illustrated in FIG. 6. Stated another way, the coil 51 of FIG. 6 includes a facing face 513 that has a rectangular shape, and can move closer to the workpiece W in such a way that distances between the coil 51 and all places of the workpiece W are less than or equal to a predetermined value. The facing face 513 extends along one plane. The facing face 513, as described above, easily moves closer to a place having large undulations on a surface, such as a corner or a recess, in the workpiece W, in comparison with a coil including the annular portion 511 or the curved face 512. This enables a heat treatment region A to be more flexibly set in the workpiece W. For example, as illustrated in FIG. 6, the coil 51 is moved in the X-direction while the workpiece W is rotated around the axis. Therefore, a spiral heat treatment region A can be formed on the side face of the workpiece W.

Further, the heat treatment mechanism 50 may include a plurality of coils 51 that is different in shape.

### Second Embodiment

A machining apparatus according to an embodiment of the present disclosure is described below with reference to the drawings.

FIGS. 1 and 2 are schematic diagrams of a machining apparatus according to an embodiment of the present disclosure. As illustrated in FIGS. 1 and 2, a machining apparatus 1 according to the present embodiment includes a support mechanism 10 that supports a workpiece W having a bar shape, a steady rest mechanism 20 that suppresses axial deflection of the workpiece W that has a bar shape, and is supported by the support mechanism 10, a cutting mechanism 30 that includes a cutting tool 311 that cuts the workpiece W supported by the support mechanism 10, a cutting fluid recovery mechanism 40 that recovers cutting fluid that has been supplied to the workpiece W in cutting, a heat treatment mechanism 50 that includes a coil 51 that performs heat treatment on the workpiece W while moving relative to the workpiece W supported by the support mechanism 10, and a coolant recovery mechanism 60 that recovers coolant that has been supplied to the workpiece W in heat treatment. The machining apparatus 1 also includes a controller 80 that controls an operation of each of the mechanisms. In addition, the machining apparatus 1 may include a machining chamber 70 that houses each of the mechanisms.

The machining apparatus 1 according to the present embodiment has a characteristic in which the heat treatment mechanism 50 employs induction heating performed by the coil 51. Induction heating is efficient because heating can be accurately and rapidly performed to a desired temperature. In addition, in the machining apparatus 1 according to the present embodiment, the workpiece W supported by the support mechanism 10 and the coil 51 move relative to each other, and therefore heat treatment using induction heating can be performed on a desired place of the workpiece W. This results in a further increase in efficiency. Moreover, in the machining apparatus 1 according to the present embodiment, the steady rest mechanism 20 suppresses axial deflection in induction heating of the workpiece W supported by the support mechanism 10. Therefore, heat treatment can be performed with high quality.

More specifically, in the machining apparatus 1 according to the present embodiment, induction heating is sequentially performed by the coil that moves from one end to another end of the workpiece W having a bar shape. Therefore, a difference in temperature can be generated between the one end and the other end. This difference in temperature can cause generation of axial deflection in induction heating of the workpiece W. In contrast, the steady rest mechanism 20 suppresses axial deflection due to the difference in temperature, and therefore heat treatment using induction heating can be performed with high quality.

The other configurations, and their functions or the like are similar to configurations and their functions or the like in the first embodiment. Therefore, description is omitted.

### Third Embodiment

The inventors have made the following consideration, and have created the present disclosure.

First, induction heating is efficient because a workpiece can be accurately and rapidly heated to a desired temperature. In view of this, the inventors have conceived of employing induction heating instead of laser hardening disclosed in JP-A-2005-238253. However, it is requested that heat treatment mechanisms that are different in a heating system have respective peculiar specifications. For example, in induction heating, disposition of a coil relative to a workpiece is important. Therefore, it is requested that a machining apparatus have an increased efficiency while such a request is satisfied.

A machining apparatus according to a third embodiment of the present disclosure is described below with reference to the drawings.

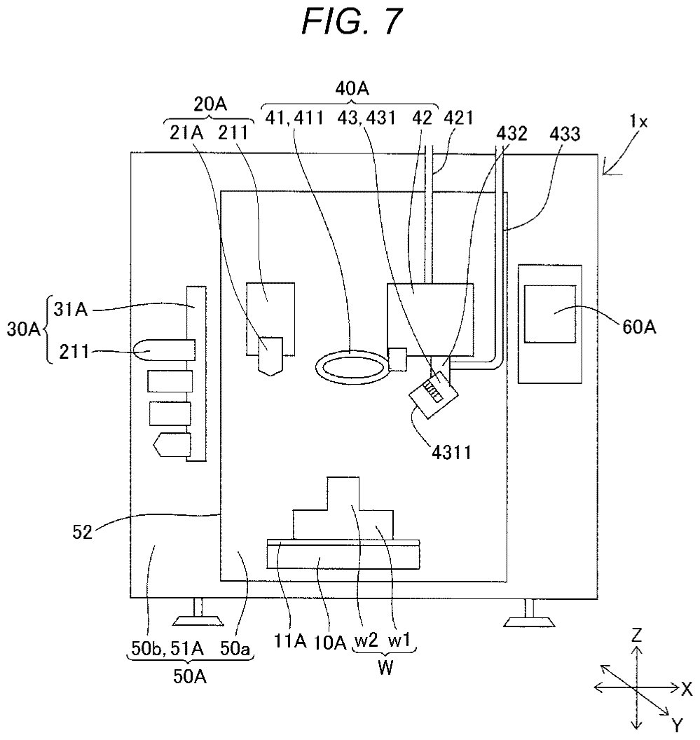

FIG. 7 is a schematic diagram of a machining apparatus in a first aspect of the third embodiment.

As illustrated in FIG. 7, a machining apparatus 1x according to the present embodiment includes a table 10A that causes a workpiece WA to be rotatable, a workpiece supporter 11A that supports the workpiece WA, a cutting mechanism 20A that cuts the workpiece WA, a tool magazine 30A that stores a plurality of cutting tools, and a heat treatment mechanism 40A that performs heat treatment on the workpiece WA by using induction heating. The machining apparatus 1x also includes a machining chamber 50A that houses each of the mechanisms, and a controller 60A that controls an operation of each of the mechanisms.

The workpiece WA according to the present embodiment includes a flange w1 having a disk shape, and an extension w2 that has a columnar shape, and extends from a center of the flange w1 in a direction that is orthogonal to a radial direction of the flange w1, as illustrated in FIG. 7. The flange w1 and the extension w2 are disposed on an identical axis line. The workpiece WA has been made of steel containing carbon.

Here, as an example of the workpiece WA according to the present embodiment, a workpiece that includes the flange w1 having a disk shape, and the extension w2 having a columnar shape has been described, but the workpiece WA is not particularly limited.

As illustrated in FIG. 7, the machining apparatus 1x according to the present embodiment is a composite apparatus that causes the workpiece WA to be rotatable, supports the workpiece WA in such a way that a rotation axis of the workpiece WA is disposed along a vertical direction, and can perform both cutting treatment and heat treatment on the workpiece WA. Here, a direction in which the rotation axis of the workpiece WA in a supported state extends (an axial direction), that is, the vertical direction, is referred to as a Z-direction. In addition, in a horizontal direction, a first horizontal direction that is orthogonal to the Z-direction is referred to as a Y-direction, and a second horizontal direction that is orthogonal to each of the Z-direction and the Y-direction is referred to as an X-direction.

The table 10A according to the present embodiment rotatably supports the workpiece WA in such a way that the rotation axis of the workpiece WA is disposed along the vertical direction.

The table 10A can rotationally move in such a way that the rotation axis of the workpiece WA is inclined relative to the vertical direction, as illustrated in FIG. 7.

In addition, the table 10A is movable in the X-direction and the Z-direction. Specifically, the table 10A includes a driver (not illustrated) that drives a movement in the X-direction and the Z-direction, and a first guide (not illustrated), such as a rail, that guides a movement in the X-direction and the Z-direction, and this enables a movement in the X-direction and the Z-direction.

The table 10A has been formed by using a material that does not cause induction heating. The material is not particularly limited, and examples include stainless steel and copper.

The workpiece supporter 11A is disposed in the table 10A, as illustrated in FIG. 7, and supports one end of the workpiece WA in such a way that the rotation axis of the workpiece WA is located along the vertical direction. Stated another way, the workpiece supporter 11A supports one side (a lower face) of the workpiece WA. The workpiece supporter 11A is, for example, a three-claw chuck, a machine vice, a clamp, or a magnet.

In addition, the workpiece supporter 11A is movable in the X-direction and the Z-direction. Specifically, the workpiece supporter 11A is disposed in the table 10A, and therefore the workpiece supporter 11A also moves in the X-direction and the Z-direction according to a movement in the X-direction and the Z-direction of the table 10A.

A material of the workpiece supporter 11A is not particularly limited. However, in a case where it is requested that the workpiece supporter 11A exhibit a shielding effect against induction heating, a material that does not cause induction heating is used. The material is not particularly limited, and examples include stainless steel and copper.

The cutting mechanism 20A according to the present embodiment is disposed above the table 10A, as illustrated in FIG. 7. The cutting mechanism 20A includes a cutter holder 21A that supports a cutting tool 211 that cuts the workpiece WA. In addition, the cutter holder 21A includes a cutting fluid supplier (not illustrated) that supplies cutting fluid to the workpiece WA, and a cutting fluid tank (not illustrated) that stores cutting fluid.

The cutter holder 21A is movable in the X-direction and the Z-direction. Specifically, the cutting mechanism 20A includes a driver (not illustrated) that drives a movement in the X-direction and the Z-direction of the cutter holder 21A, and a second guide (not illustrated), such as a rail, that guides a movement in the X-direction and the Z-direction of the cutter holder 21A, and this enables the cutter holder 21A to move in the X-direction and the Z-direction.

In addition, the cutter holder 21A can rotate the cutting tool 211 around an axis of the cutting tool 211 (with the Z-direction as an axis). In addition, the cutter holder 21A can rotationally move the cutting tool 211 in such a way that the cutting tool 211 enters into a first state where the rotation axis of the cutting tool 211 is located along one direction (for example, the Z-direction), or a second state where the rotation axis is inclined in an arbitrary direction relative to the first state.

As the cutting tool 211, for example, a milling cutter and an end mill can be used in a case where the cutting tool 211 is rotated. In a case where the cutting tool 211 is not rotated, for example, a throw-away tip of cemented carbide can be used.

The cutting fluid supplier (not illustrated) moves in the X-direction and the Z-direction together with the cutting tool 211 according to a movement of the cutter holder 21A, and cutting fluid can be supplied to a cut face.

Cutting fluid that has been injected by the cutting fluid supplier (not illustrated) can be recovered in the machining apparatus 1x. Specifically, the machining apparatus 1x includes a cutting fluid recovery mechanism (not illustrated) that recovers cutting fluid that has been supplied to the workpiece WA. The cutting fluid recovery mechanism (not illustrated) according to the present embodiment is a circulation type mechanism that performs filtration treatment on cutting fluid supplied to the workpiece WA, recovers cutting fluid from which a chip has been removed, and supplies the cutting fluid to the cutting fluid supplier.

The tool magazine 30A according to the present embodiment is disposed in a first isolation chamber 51A of the machining chamber 50A in order to protect the cutting tool 211 from a chip, cutting fluid, or the like, as illustrated in FIG. 7. The machining chamber 50A has been sectioned by an isolation wall 52 into a machining area 50a where machining is performed on the workpiece WA, and a storage area 50b where the cutting tool 211 is stored. In addition, the first isolation chamber 51A includes an opening/closing portion that connects the machining area 50a to the storage area 50b in such a way that the cutting tool 211 can be delivered between the cutting mechanism 20A and the tool magazine 30A. The opening/closing portion may be provided by employing the isolation wall 52 having a shutter structure.

The tool magazine 30A includes an automated tool changer (ATC, not illustrated) that enables the cutting mechanism 20A to change the cutting tools 211. Specifically, the tool magazine 30A includes a rotary drum 31A that holds a plurality of tool holders 311 in such a way that the plurality of tool holders 311 is arranged along an outer periphery. In addition, the automated tool changer includes a conveyer that enables the cutting tool 211 to be delivered between the cutter holder 21A of the cutting mechanism 20A and the rotary drum 31A. The conveyer may include an arm that is movable between the cutter holder 21A and the rotary drum 31A, and a clamp that grasps the cutting tool 211.

The heat treatment mechanism 40A according to the present embodiment performs quenching for hardening a surface of the workpiece WA, as illustrated in FIG. 7. The heat treatment mechanism 40A is disposed above the table 10A.

The heat treatment mechanism 40A includes a coil 41 that performs induction heating on the workpiece WA, a high-frequency power supply 42 that adjusts a frequency of a voltage to be applied to the coil 41, a coolant supplier 43 that supplies the workpiece WA with coolant, and a coolant tank (not illustrated) that stores coolant.

In the present embodiment, the coil 41 and the coolant supplier 43 are mounted on the high-frequency power supply 42. In addition, the high-frequency power supply 42 is movable relative to the workpiece WA. Accordingly, the coil 41 and the coolant supplier 43 are movable relative to the workpiece WA according to a movement of the high-frequency power supply 42 relative to the workpiece WA.

The coil 41 performs induction heating on the workpiece WA in such a way that a temperature on a surface of the workpiece WA becomes 100° C. to 1200° C.

The coil 41 includes an annular portion 411 that can surround the flange w1 of the workpiece WA. Accordingly, the annular portion 411 of the coil 41 can also surround the extension w2 of the workpiece WA. The annular portion 411 has been formed by using a copper tube that spirally runs along a circle having a predetermined diameter. In other words, the coil 41 includes an annular turn coil.

Note that an example where a shape of the coil 41 includes an annular portion has been described, but the shape of the coil 41 is not particularly limited. Examples of the shape include a bar shape, an arc shape, and a spiral shape.

The coil 41 moves downward according to a movement in the Z-direction of the high-frequency power supply 42, and the workpiece WA can be disposed inside the annular portion 411. In the present embodiment, the coil 41 is mounted on the high-frequency power supply 42, as described above. In addition, the coil 41 and the high-frequency power supply 42 are connected to each other by a coil lead (not illustrated). The high-frequency power supply 42 is, for example, a matching transformer or a current transformer.

In addition, in the coil 41 and the coil lead, a cover (not illustrated) that avoids a short circuit due to a chip may be used. However, less power is lost in a case where the coil 41 and the high-frequency power supply 42 are connected by a short coil lead. Therefore, it is preferable that the coil 41 be mounted on the high-frequency power supply 42. In addition, in order to avoid attachment of a chip or cutting fluid to the coil 41 in cutting treatment, it is preferable that the coil 41 be mounted on the high-frequency power supply 42.

Further, in the coil 41, a frequency of a voltage to be applied to the workpiece WA can be set to range from 0.3 kHz to 400 kHz. The frequency can be set according to a model or specifications of the high-frequency power supply 42. This enables the coil 41 to generate high-frequency induction heating in the workpiece WA. The high-frequency power supply 42 includes a cold-water cable 421 that is used to internally circulate cold water.

The high-frequency power supply 42 is movable in the X-direction and the Z-direction. Specifically, the heat treatment mechanism 40A includes a driver (not illustrated) that drives a movement in the X-direction and the Z-direction of the high-frequency power supply 42, and a third guide (not illustrated), such as a rail, that guides a movement in the X-direction and the Z-direction of the high-frequency power supply 42, and this enables the high-frequency power supply 42 to move in the X-direction and the Z-direction.

Note that the high-frequency power supply 42 may be guided by the second guide of the cutting mechanism 20A instead of the third guide. Stated another way, the heat treatment mechanism 40A and the cutting mechanism 20A may share a single guide.

The coolant supplier 43 can supply the workpiece WA with coolant within 3.0 seconds after induction heating of the workpiece WA. The coolant supplier 43 includes an injector 431 that supplies coolant to a surface of the workpiece WA, a rotational movement portion 432 that rotationally moves the injector 431, and a branch pipe 433 that has a long shape, and has been branched from the injector 431.

The injector 431 is mounted on the high-frequency power supply 42. The injector 431 can supply coolant to a predetermined position of the workpiece WA according to a movement of the high-frequency power supply 42. It is requested that mixture of coolant in cutting fluid be avoided, and coolant be supplied to the workpiece WA within a predetermined time period after induction heating. Therefore, it is preferable that the injector 431 be mounted on the high-frequency power supply 42.

The injector 431 includes an injection port 4311 that injects coolant.

The rotational movement portion 432 may rotationally move the injector 431 in such a way that an orientation of the injection port 4311 can be adjusted to supply coolant to a heated region of the workpiece WA. In addition, the rotational movement portion 432 may be able to inject coolant from the injection port 4311 in a direction that is inclined by a predetermined angle relative to the Z-direction, by inclining the injector 431.

A terminal end (an end on an opposite side of a connection end of the injector 431) of the branch pipe 433 is connected to the coolant tank with a pump interposed therebetween.

In the present embodiment, coolant that has been injected by the coolant supplier 43 can be recovered in the machining apparatus 1x. Specifically, the machining apparatus 1x includes a coolant recovery mechanism (not illustrated) that recovers coolant that has been supplied to the workpiece WA inside the machining apparatus 1x (specifically, in the machining area 50a). The coolant recovery mechanism (not illustrated) is a circulation type mechanism that recovers coolant that has been supplied to the workpiece WA, and supplies the coolant to the coolant supplier.

While operation is not performed, the heat treatment mechanism 40A according to the present embodiment is stored in a second isolation chamber (not illustrated) in the machining chamber 50A. Specifically, while operation is not performed and cutting treatment is performed on the workpiece WA, the heat treatment mechanism 40A is stored in the second isolation chamber in order to avoid attachment of cutting fluid or a chip. Note that the heat treatment mechanism 40A may be protected by an isolation wall that avoids attachment of cutting fluid or a chip. In the machining chamber 50A according to the present embodiment, at least a first isolation wall 51A may be formed by using a material that can shield a magnetic flux induced by the coil 41. An example of such a material is nonferrous metal in which electromagnetic induction is caused.

The controller 60A according to the present embodiment controls an amount of movement of each of the mechanisms described above, the speed of rotation of the table 10A or the cutting tool 211, supporting performed on the workpiece WA by workpiece supporter 11A, a timing at which cutting fluid or coolant is supplied and a supply amount of cutting fluid or coolant, and the like.

Next, an operation of the machining apparatus 1x according to the present embodiment is described by using, as an example, a case where heat treatment is performed after cutting treatment has been performed on the workpiece WA. Note that the machining apparatus 1x may perform cutting treatment after heat treatment has been performed on the workpiece WA. In addition, the machining apparatus 1x may simultaneously perform cutting treatment and heat treatment. Further, the numbers of times of cutting treatment and heat treatment can be appropriately changed or set.

### (Preparation Stage)

First, in the machining apparatus 1x, the table 10A causes the workpiece WA to be rotatable in such a way that the rotation axis is located along the horizontal direction, and the workpiece supporter 11A including the table 10A supports the workpiece WA.

### (Cutting Treatment Stage)

The machining apparatus 1x moves the cutter holder 21A relative to the workpiece WA to a predetermined position of the workpiece WA. At this time, the workpiece WA is rotated in such a way that the rotation axis of the workpiece WA is located along the vertical direction, as needed. Next, the cutting tool 211 is advanced to come into contact with the workpiece WA, and the cutting fluid supplier supplies cutting fluid to the workpiece WA, and therefore cutting treatment is performed on the workpiece WA. At this time, the cutting tool 211 is rotated around the axis, as needed. In addition, the cutting tool 211 may be aligned relative to the workpiece WA by moving the table 10A in the X-direction or the Z-direction, and also moving the cutter holder 21A in the X-direction or the Z-direction.

### (Heat Treatment Stage)

The machining apparatus 1x moves the coil 41 relative to the workpiece WA to a predetermined position of the workpiece WA, and the coolant supplier 43 supplies coolant to the workpiece WA within a predetermined time period (for example, 3.0 seconds) after induction heating has been performed on the workpiece WA. At this time, the workpiece WA is rotated, as needed. By doing this, a surface of the workpiece WA is hardened. In heat treatment, it is sufficient if the workpiece WA is not rotated. However, the workpiece WA may be rotated in order to uniformly heat the workpiece WA. In addition, the coil 41 may be aligned relative to the workpiece WA by moving the table 10A including the workpiece supporter 11A in the X-direction or the Z-direction, and also moving the coil 41 in the X-direction or the Z-direction.

Next, a machining apparatus in a second aspect of the third embodiment of the present disclosure is described. Note that a configuration that is identical to the machining apparatus 1x in the first aspect of the third embodiment is denoted by an identical reference sign, and description of the configuration is omitted.

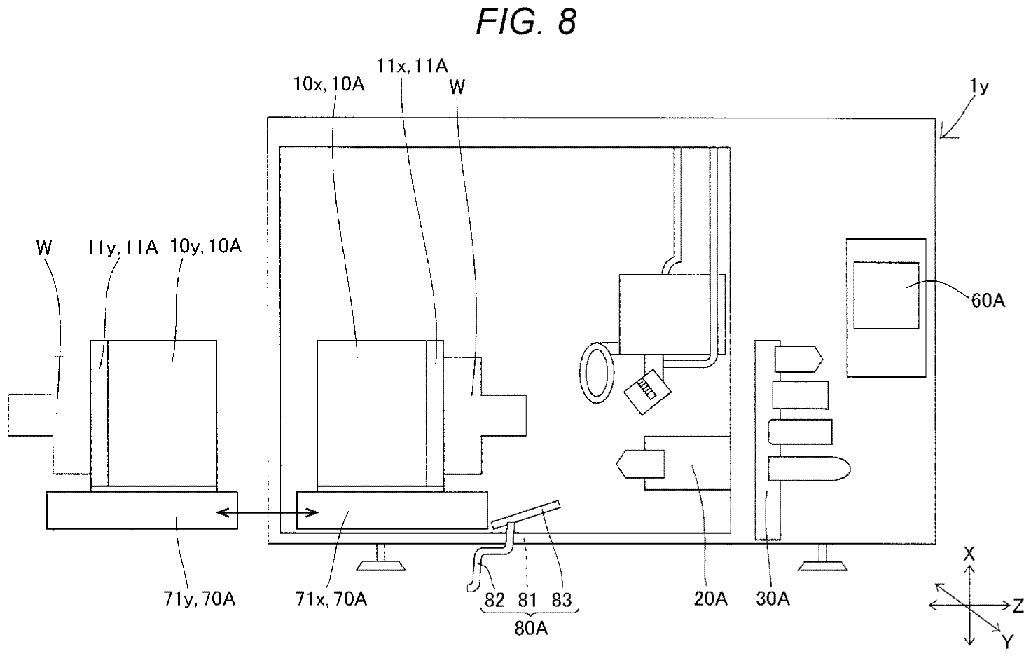

As illustrated in FIG. 8, a machining apparatus 1y according to the present embodiment is an apparatus that supports a workpiece WA in such a way that a rotation axis is located along the horizontal direction, and performs both cutting treatment and heat treatment on the workpiece WA. Here, a direction in which the rotation axis of the workpiece WA in a supported state extends (an axial direction), that is, the horizontal direction, is referred to as a Z-direction. In addition, in the horizontal direction, a horizontal direction that is orthogonal to the Z-direction is referred to as a Y-direction. Further, a direction that is orthogonal to each of the Z-direction and the Y-direction, that is, the vertical direction, is referred to as an X-direction.

As illustrated in FIG. 8, the machining apparatus 1y according to the present embodiment includes a plurality of tables 10A, a plurality of workpiece supporters 11A, the cutting mechanism 20A, the tool magazine 30A, the heat treatment mechanism 40A, the machining chamber 50A, and the controller 60A, and also includes a palette changer 70A and a plurality of palettes 71 that enable the tables 10A to be exchanged between an inside and an outside of the machining chamber 50A, and a coolant recovery mechanism 80A that recovers coolant supplied to the workpiece WA in heat treatment.

The tables 10A according to the present embodiment include a plurality of tables 10x and 10y that enables the workpiece WA to rotate in such a way that the rotation axis is located along the horizontal direction, as illustrated in FIG. 8.

The workpiece supporters 11A are disposed in the tables 10A, as illustrated in FIG. 8, and include a plurality of workpiece supporters 11x and 11y that supports one end of the workpiece WA in such a way that the rotation axis of the workpiece WA is located along the horizontal direction.

The palette changer 70A includes a plurality of palettes 71x and 71y on which the table 10A is placed, as illustrated in FIG. 8. The palettes 71x and 71y are movable in the X-direction and the Z-direction inside the machining chamber 50A. Specifically, the palette changer 70A includes a driver (not illustrated) that drives a movement in the X-direction and the Z-direction, and an in-chamber guide (not illustrated), such as a rail, that guides a movement in the X-direction and the Z-direction, and this enables the palettes 71x and 71y to move in the X-direction and the Z-direction.

In addition, the palette changer 70A includes an out-chamber guide (not illustrated) that is branched from the in-chamber guide, and extends to an outside of the machining chamber 50A. Such an out-chamber guide enables the palette changer 70A to exchange the palette 71x inside the machining chamber 50A with the palette 71y outside the machining chamber 50A. As a result, according to such a movement of the palettes 71x and 71y, the table 10x and the workpiece supporter 11x that are located inside the machining chamber 50A can be exchanged with the table 10y and the workpiece supporter 11y that are located outside the machining chamber 50A. Accordingly, the workpieces WA before and after cutting treatment or before and after heat treatment can be exchanged in the machining chamber 50A. In a case where it has been recognized that a chip or cutting fluid has been attached to the workpiece WA after cutting treatment, it is preferable that before heat treatment, such a workpiece WA be moved to the outside of the machining chamber 50A, and pretreatment for removing the chip or the like be performed. By including the palette changer 70A, such pretreatment is easily performed. In addition, during such pretreatment, cutting treatment or heat treatment can be performed on another workpiece WA, and this results in an increase in efficiency.

A single table 10x or 10y is placed on each of the palettes 71x and 71y. The palette 71x or 71y is rotationally movable in such a way that the rotation axis of the workpiece WA is inclined relative to the horizontal direction.

As illustrated in FIG. 8, the coolant recovery mechanism 80A according to the present embodiment includes a receiver 81 that receives coolant that has been supplied to the workpiece WA, a recovery pipe 82 that recovers coolant in the receiver 81, and a lid 83 that enables the receiver 81 to be opened or closed.

The receiver 81 includes a container that has been embedded into a bottom of the machining chamber 50A, and is open on an upper side. In addition, the recovery pipe 82 performs suction to recover coolant. The recovery pipe 82 is connected to the coolant tank. This enables circulation use of coolant.

The lid 83 enters into an open state where the receiver 81 is open, when the coolant supplier 43 supplies coolant to the workpiece WA. The lid 83 enters into a closed state where the receiver 81 is closed, when it is not requested that the coolant supplier 43 supply coolant, for example, in cutting treatment or induction heating.

As described above, two aspects of the embodiment have been described as an example, but a machining apparatus according to the present disclosure is not limited to configurations in the aspects described above. In addition, the machining apparatus according to the present disclosure is not limited to the effects described above. Various changes can be made to the machining apparatus according to the present disclosure without departing from the gist of the present disclosure.

In addition, in the embodiment described above, the heat treatment mechanism 40A performs quenching as heat treatment. However, this is not restrictive, and the heat treatment mechanism may perform normalizing, high-frequency heating, high-frequency tempering, high-frequency annealing, or the like.

In addition, in the embodiment described above, the coil 41 including the annular portion 411 has been described as an example. However, this is not restrictive, and the coil 41 may include a curved face that faces a side face of the extension w2 of the workpiece WA. Therefore, the coil 41 may be movable around the workpiece WA to arbitrarily adjust a distance between the curved face and the workpiece WA.

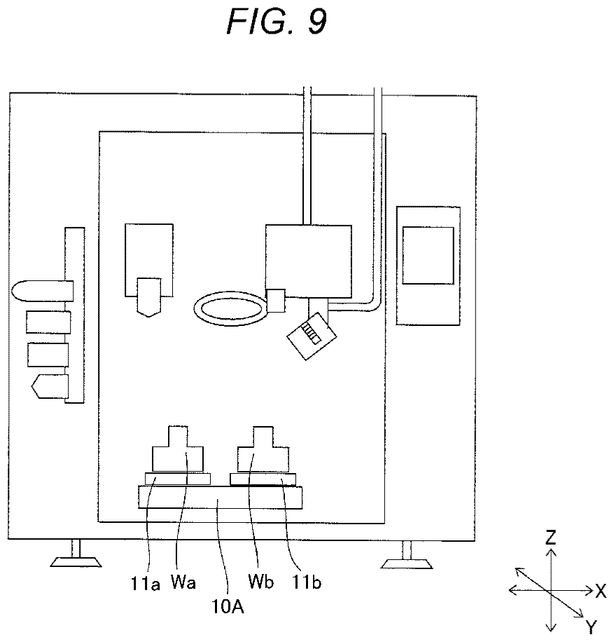

In addition, the table 10A may have the aspect illustrated in FIG. 9. Stated another way, FIG. 9 illustrates workpieces WB and WC, and these plural workpieces may be disposed on the table 10A. In this case, a single table 10A may configure a plurality of workpiece supporters 11a and 11b, as illustrated in FIG. 9. In addition, the plurality of workpieces may be identical to each other, or may be different from each other (in an external form, a size, or a supported state). Moreover, the plurality of workpiece supporters may be identical to each other, or may be different from each other.

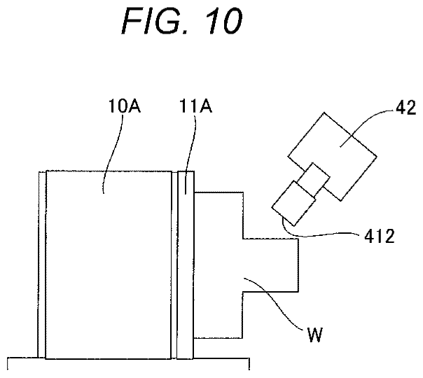

In addition, the coil 41 may have the aspect illustrated in in FIG. 10. Specifically, the coil 41 of FIG. 10 includes a facing face 412 that has a rectangular shape, and can move closer to the workpiece WA in such a way that distances between the coil 41 and all places of the workpiece WA are less than or equal to a predetermined value. The facing face 412 is disposed along one plane. The facing face 412, as described above, is easily brought closer to a place having large undulations on a surface, such as a corner or a recess, in the workpiece WA, in comparison with the annular portion 411 or the like. This enables a heat treatment region to be flexibly set in the workpiece WA. For example, as illustrated in FIG. 10, a heat treatment region that is continuous from the flange w1 to the extension w2 of the workpiece WA can be formed by moving the facing face 412 along an outer edge of the workpiece WA.

Moreover, the heat treatment mechanism 40A may include a plurality of coils 41 that is different in shape.

What is claimed is:

1. A machining apparatus comprising:
a support mechanism that supports a workpiece;
a cutting mechanism that cuts the workpiece that has been supported by the support mechanism; and
a heat treatment mechanism that performs heat treatment on the workpiece that has been supported by the support mechanism, wherein
the heat treatment mechanism includes a coil that performs induction heating on the workpiece,
the workpiece that has been supported by the support mechanism and the coil are movable relative to each other,
a machining chamber that houses each of the mechanisms,
a cutting fluid recovery mechanism that recovers cutting fluid that has been supplied to the workpiece in cutting
a coolant recovery mechanism that recovers coolant that has been supplied to the workpiece in the heat treatment; and
the coolant recovery mechanism includes a receiver that is disposed in a bottom of the machining chamber, and is open on an upper side,
a recovery pipe that recovers coolant in the receiver,
a leader that is located above the receiver, is connected to the recovery pipe, and leads coolant in the receiver to the recovery pipe.

2. The machining apparatus according to claim 1, wherein
the leader includes a lower end that is connected to the recovery pipe, and an upper end that is disposed below the workpiece, and is inclined from the upper end to the lower end.
